(19) United States
(12) Patent Application Publication
(10) Pub. No.: US 2014/0282938 A1
(43) Pub. Date: Sep. 18, 2014

(54) METHOD AND SYSTEM FOR INTEGRATED CLOUD STORAGE MANAGEMENT

(71) Applicant: Adam Moisa, Jamaica, NY (US)

(72) Inventor: Adam Moisa, Jamaica, NY (US)

(73) Assignee: Adam Moisa, Jamaica, NY (US)

(21) Appl. No.: 13/839,793

(22) Filed: Mar. 15, 2013

(51) Int. Cl. H04L 29/06

(52) U.S. Cl. CPC H04L 63/08
USPC 726/6

(57) ABSTRACT

A system and method for integrating a plurality of cloud storage accounts, including the steps of receiving login data of a user account, receiving a notification of at least one of the cloud storage accounts to associate with the user account, receiving authentication data of the at least one cloud storage accounts, transmitting the authentication data to the respective cloud storage account, receiving at least one authentication token from each of the respective cloud storage accounts when the authentication data is verified, storing the at least one authentication token in a database and associating the at least one authentication token with the user account, and receiving at least one file from the at least one cloud storage account associated with the user account.

### TECHNICAL FIELD

The present disclosure relates to a method and system for integrated cloud storage management. In particular, the present disclosure relates to a method and system for integrating and managing multiple user cloud storage accounts in a single central user account.

### BACKGROUND

Cloud-based storage is a very convenient method for file storage. It allows the user access to files regardless of the location of a computer, and it offers a convenient means of sharing. With many different companies offering cloud storage services, the consumer has a wide choice of options of where to store files. Many suppliers offer this storage free or for a charge, although at a very limited capacity. Because of the capped or limited storage space offered to each account, users tend to open more than one storage account with either the same supplier or different suppliers. Furthermore, there are many other reasons to have multiple accounts, such as sharing preferences, automatic creation, special offer opportunities, etc. Therefore, many consumers have multiple accounts with the same company and many accounts across different suppliers. While very useful, owning and managing multiple cloud storage accounts can be very challenging and tedious for the consumer.

Although creating multiple cloud storage accounts increases a user's storage capacity, it creates its own usage challenges. Primarily, there is a scattering of files across multiple different cloud storage accounts and companies. As a result, it is difficult for the user to track and manage these files between the multiple accounts. Additionally, it is difficult for the user to transfer the files from one cloud storage account to another cloud storage account. Further, it is particularly difficult to quickly search all of the cloud storage accounts using a single search function. There is no systematic organization and the need to search through each of the multiple cloud storage accounts is time consuming and inefficient. Additionally, with only a limited capacity available in each cloud storage account, files that are larger in size than the available space on a single cloud storage account cannot be stored on any of the cloud storage accounts.

Accordingly, a need exists for an efficient means of integrating multiple cloud storage accounts into a single user account where all of the data and files from each of the cloud storage accounts are accessible, manageable, and organized in a single user interface. Further, a need exists for an efficient means for searching through all of the cloud storage accounts using a single search function. Additionally, a need exists for a means to store files that are larger than any individual storage account, or the space available in any of the individual storage accounts.

### SUMMARY

The present disclosure is directed to a method and system for integrated cloud storage management.

A method for integrating a plurality of cloud storage accounts, according to a preferred embodiment of the present disclosure, includes the steps of receiving login data of a user account, receiving a notification of at least one of the cloud storage accounts to associate with the user account, receiving authentication data of the at least one cloud storage accounts, transmitting the authentication data to the respective cloud storage account, receiving at least one authentication token from each of the respective cloud storage accounts when the authentication data is verified, storing the at least one authentication token in a database and associating the at least one authentication token with the user account, and receiving at least data of at least one file stored on at least one cloud storage account associated.

The method may further include the step of determining the type of categorizing or sorting the files based on the file type. Additionally, the method may further include the step of receiving a command to upload a local file or folder of files from a local memory or database and searching the cloud storage accounts to determine if sufficient space is available on any of the cloud storage accounts to store the file or folder. Additionally, the method may further include storing the local file in the cloud storage account that includes sufficient storage space available. Alternatively, the method may include the step of partitioning or splitting the local file into parts and storing each of the parts in different cloud storage accounts that have sufficient available storage space to store the parts. The parts may be labeled, marked, or tagged as non-movable.

The method may further include the steps of receiving data corresponding to the local file or a file stored on any cloud storage account, associating the data with the respective file, and searching the files based on the data associated with the files. The method may further include the steps of determining whether any of the cloud storage accounts associated with the user account are approaching capacity and notifying the user account that the cloud storage account includes an available capacity below a predetermined or predefined threshold level.

A system for integrating a plurality of cloud storage accounts is also provided. The system includes a processor, and a memory storing instructions executable by the processor, wherein the instructions when executed by the processor cause the system to receive login data of a user account, receive a notification of at least one of the cloud storage accounts to associate with the user account, receive authentication data of the at least one cloud storage accounts, transmit the authentication data to the respective cloud storage account, receive at least one authentication token from each of the respective cloud storage accounts when the authentication data is verified, store the authentication token in a database and associate the at least one authentication token with the user account, and receive at least data of at least one file stored on at least one cloud storage account associated.

The data received may include data indicating the type of file, and the instructions when executed by the processor may further cause the system to categorize the file based on the type of file. Additionally, the instructions when executed by the processor may further cause the system to receive a command to upload a local file, search the cloud storage accounts and determine if sufficient space is available to store the local file in at least one cloud storage account. Additionally, the instructions when executed by the processor may further cause the system to store the local file in at least one cloud storage account when sufficient space is available in at least one cloud storage account. Additionally, the instructions when executed by the processor may further cause the system to split the local file into parts and store each of the parts in a different cloud storage account when sufficient space is not available in at least one cloud storage account. The parts may be labeled, marked, or tagged as non-movable.

Additionally, the instructions when executed by the processor may further cause the system to receive data corresponding to at least one of the local file and at least one file stored on any cloud storage account, associate the data with the respective file, and search the files based on the data associated with the files. Additionally, the instructions when executed by the processor further cause the system to determine whether at least one of the cloud storage accounts includes an available capacity below a predefined threshold level, and notify the user account that at least one of the cloud storage accounts includes an available capacity below the predefined threshold level.

Also provided is a non-transitory computer-readable storage medium storing a program for causing a computer to execute a method for integrating a plurality of cloud storage accounts including the steps of receiving login data of a user account, receiving a notification of at least one of the cloud storage accounts to associate with the user account, receiving authentication data of the at least one cloud storage accounts, transmitting the authentication data to the respective cloud storage account, receiving at least one authentication token from each of the respective cloud storage accounts when the authentication data is verified, storing the at least one authentication token in a database and associating the at least one authentication token with the user account, and receiving at least data of at least one file stored on at least one cloud storage account associated.

The data of the file received may include data corresponding to the file type, and the instructions when executed by the computer may further cause the computer to categorize the at least one file based on the file type. Additionally, the program may further cause the computer to receive a command to upload a local file, and search the cloud storage accounts and determine if sufficient space is available to store the local file in at least one cloud storage account. Additionally, the program may further cause the computer to store the local file in at least one cloud storage account with sufficient space available when sufficient space is available in at least one cloud storage account. Additionally, the program may further cause the computer to split the local file into parts and store each of the parts in a different cloud storage account when sufficient space is not available in at least one cloud storage account, optionally mark the parts as non-movable. Additionally, the program may further cause the computer to receive data corresponding to at least one of the local file and at least one file stored on any cloud storage account, associate the data with the respective file, and search the files based on the data associated with the files.

### BRIEF DESCRIPTION OF THE DRAWINGS

The accompanying drawings, which are incorporated in and constitute a part of this specification, illustrate embodiments of the disclosure, and together with a general description of the disclosure given above, and the detailed description of the embodiments given below, serve to explain the principles of the present disclosure.

FIG. 1 is a view showing an example system for integrated cloud storage management according to an embodiment of the present disclosure;

FIG. 2 is a block diagram showing the components of the system illustrated in FIG. 1;

FIG. 3 is a flow chart of a method for integration of multiple cloud storage accounts in accordance with an embodiment of the present disclosure;

FIG. 4 is a flow chart of a method for uploading at least one file or folder to a user account according to an embodiment of the present disclosure;

FIG. 5 is a flow chart of a method for tagging files and searching integrated cloud storage accounts according to an embodiment of the present disclosure;

FIG. 6 is a block diagram illustrating an authorization exchange between the system and a cloud storage account according to an embodiment of the present disclosure;

FIG. 7 is a drawing of an exemplary user interface illustrating a home screen of the system according to an embodiment of the present disclosure;

FIG. 8 is a drawing of an exemplary user interface illustrating a split-screen view of multiple cloud storage accounts associated with one user account of the system according to an embodiment of the present disclosure;

FIG. 9 is a drawing of an exemplary user interface according to an embodiment of the present disclosure;

FIG. 10 is a drawing of an exemplary user interface showing conferences and files according to an embodiment of the present disclosure; and

FIG. 11 is a drawing of an exemplary user interface showing multiple cloud storage accounts associated with a single user account, according to an embodiment of the present disclosure.

### DETAILED DESCRIPTION

FIG. 1 illustrates an example system 10 for integrating a plurality of cloud storage accounts according to certain embodiments of the present disclosure. System 10 includes devices 110 which communicate through integration system 200 to cloud storage accounts 121, 123, 125 (referred to herein collectively as cloud storage accounts 120). Each user 101 may control integration system 200 via a device 110 for integrating and managing multiple cloud storage accounts 120. Although this particular implementation of system 10 for integrating a plurality of cloud storage accounts 120 is illustrated and primarily described, the present disclosure contemplates any suitable network implementation of system 10 for integrating a plurality of cloud storage accounts 120, or any of its components, according to particular needs of the institution or facility.

Continuing with reference to FIG. 1, although three cloud storage accounts 120 are illustrated and described, it is envisioned that one, two, or any number of cloud storage accounts 120 may be implemented by system 10. Cloud storage accounts 120 may include any remote storage means including, without limitation, online storage means. Cloud storage accounts 120 may be, for example and without limitation, Google Drive®, DropBox®, Box.net®, and the like.

Continuing with reference to FIG. 1, users 101 may be individuals that own cloud storage accounts 120 or otherwise have access to the cloud storage accounts 120. Devices 110 may be any device that is capable of receiving input data from users 101 and transmitting the data to integration system 200. For example and without limitation, device 110 may be a desktop computer, laptop computer, tablet device, mobile device such as a cellular phone, or any other device suitable for, and capable of, transmitting data between devices 110, integration system 200, and cloud storage accounts 120. Although system 200 and device 110 are shown and described as two separate components, it some embodiments system 200 and device 110 are a single device. For example and without limitation, in particular embodiments, device 110 includes all of the hardware, software, and executable instructions necessary to process the methods described herein.

Turning now to FIG. 2, and continuing with reference to FIG. 1, integration system 200 of system 10 for integrating a plurality of cloud storage accounts 120, will now be described with particular detail. Integration system 200 may include a central processing unit 201, a storage unit, memory and/or database 203, a receiving unit 205, a sending unit 207, input 209, and output 211. Input 209 may be any suitable form of data input such as and without limitation a keyboard and/or touch screen. Output 211 may be any suitable output such as and without limitation a display, monitor, output unit, and/or touch screen. It is understood, that although particular units and/or components of integration system 200 described below are described as being configured to perform particular tasks or functions, any of the units of integration system 200 may be capable of performing any of the tasks of any of the other units of integration system 200. The term “unit,” as used herein, may include modules, software and/or hardware, components, digital or analog, that cooperate to perform one or more control tasks and may include digital commands, power circuitry, networking hardware, an/or a set of programmable instructions for implementation and execution by at least one processor, or central processing unit 201, to carry out any of the steps described herein.

Additionally, or alternatively, integration system 200 may partially or entirely take the form of device 110. For example, in particular embodiments, device 110 may include all of the components of integration system 200, such as processor 201, memory 203, receiving unit 205, sending unit 207, input 209, and output 211 and may be configured to perform any of the functions described herein.

Continuing with reference to FIG. 2, the processor 201 of integration system 200 is configured to process any of the steps or functions of integration system 200 and/or any of the modules or units therein. The term processor, as used herein, may be any type of controller or processor, and may be embodied as one or more controllers or processors adapted to perform the functionality discussed herein. Additionally, as the term processor is used herein, a processor may include use of a single integrated circuit (IC), or may include use of a plurality of integrated circuits or other components connected, arranged or grouped together, such as controllers, microprocessors, digital signal processors, parallel processors, multiple core processors, custom ICs, application specific integrated circuits, field programmable gate arrays, adaptive computing ICs, associated memory, such as and without limitation, RAM, DRAM and ROM, and other ICs and components.

Continuing with reference to FIG. 2, the database or memory 203 of integration system 200 may be configured to store information pertinent to users 101, user accounts which are associated with each user 101, user profiles and user data, history of transactions, cloud storage accounts 120 of users 101, tokens, login and authentication information of users 101, and any other such data as may be deemed necessary for implementation of the methods described herein. Memory 203 may also be configured to store files and data associated with the files, such as and without limitation, metadata and tags associated with the respective files, as will be described in further detail below. Files may be stored locally within the memory 203 and/or on cloud storage accounts 120. Additionally, or alternatively, database 203 of integration system 200 may be tied to a third-party payment system, such as and without limitation, PayPal®, or may otherwise be configured to store payment data of users 101.

As used herein, the term database, memory, and/or storage unit may be understood to include, and is not limited to, repository, databank, database, cache, storage unit, cloud, and the like, a data repository, any computer or other machine-readable data storage medium, memory device or other storage or communication device for storage or communication of information, currently known or which becomes available in the future, including, but not limited to, a memory integrated circuit, or memory portion of an integrated circuit (such as the resident memory within a processor), whether volatile or non-volatile, whether removable or non-removable, including without limitation RAM, FLASH, DRAM, SDRAM, SRAM, MRAM, FeRAM, ROM, EPROM or E2PROM, or any other form of memory device, such as a magnetic hard drive, an optical drive, a magnetic disk or tape drive, a hard disk drive, other machine-readable storage or memory media such as a floppy disk, a CDROM, a CD-RW, digital versatile disk (DVD) or other optical memory, or any other type of memory, storage medium, or data storage apparatus or circuit, which is known or which becomes known, depending upon the selected embodiment.

Additionally, or alternatively, such computer readable media includes any form of communication media which embodies computer readable instructions, data structures, program modules or other data in a data signal or modulated signal, such as an electromagnetic or optical carrier wave or other transport mechanism, including any information delivery media, which may encode data or other information in a signal, wired or wirelessly, including electromagnetic, optical, acoustic, RF or infrared signals, and so on. The memory may be adapted to store various look up tables, parameters, coefficients, other information and data, programs or instructions (of the software of the present embodiments), and other types of tables such as database tables.

Continuing with reference to FIG. 2, the receiving unit 205 of integration system 200 may be configured to receive user data, such as and without limitation, user login and authentication information for a user account within integration system and/or login and authentication information for cloud storage accounts 120. In particular, the receiving unit 205 may receive information or data, such as and without limitation, data associated with the username and password for the user account and a plurality of cloud storage accounts 120.

Additionally, the receiving unit 205 may be configured to receive authentication tokens from cloud storage accounts 120 for storage in memory 203. Additionally, receiving unit 205 may also be configured to receive files, folders, and/or data associated with files and/or folders which may be stored locally on memory 203 or within one of the cloud storage accounts 120. In particular, in one embodiment, receiving unit 205 is configured to receive files and/or data associated with files locally stored in memory 203. Additionally, receiving unit 207 may be configured to receive files and/or data associated with files stored on one or more cloud storage accounts 120. In embodiments, receiving unit 205 is configured to determine the type of file or data received. In particular, receiving unit 205 is configured to determine if a file is a music file, document file, video file, audio file, partitioned file, metadata, etc.

As used herein, the term file may be understood to include, and is not limited to a file, data associated with a file, executable instructions, shortcuts or locations of a file or files, folders storing files, and any combination or variations thereof.

Continuing with reference to FIG. 2, the sending unit 207 may be configured to send the information received by receiving unit 205 to each of the cloud storage accounts 120 and/or memory 203. In particular, sending unit 207 may be configured to deliver authentication information of a user 101 to each of the cloud storage accounts 120. In an embodiment, sending unit 207 is configured to send files from one cloud storage account 121 to a different cloud storage account 122. Additionally, sending unit 207 may be configured to determine the storage space available on each cloud storage account 120, and perform a partitioning function of a file or folder containing files. In particular, the sending unit 207 can split files and/or folders into parts and send the parts to different cloud storage accounts 120. In embodiments, sending unit 207 is further configured to automatically move files between cloud storage accounts 120. Additionally, in particular embodiments, sending unit 207 is configured to send notifications to users 101, devices 110, and/or cloud storage accounts 120.

In an embodiment, system 200 is configured to display all of the files and folders, and data associated with the files and folders, which are stored on one or more cloud storage accounts 120 and/or memory 203, in a single user interface or folder. In this embodiment, a user is no longer required to switch between different cloud storage accounts 120 to view and access the files and data stored on each respective cloud storage account 120. In another embodiment, system 200 is configured to display one or more of the cloud storage accounts 120 associated with the user account on a single user interface. In this embodiment, the user may transfer files between different cloud storage accounts 120 via system 200 by using for example a drag-and-drop method or the move functions described in further detail below.

In an additional embodiment, system 200 may be configured to perform a temporary (or optionally permanent) reorganization overview function. In particular, system 200 may organize, or otherwise rearrange, the files, folder, and/or data based on different factors, such as and without limitation, file name, size, creation date, upload date, date of last edit, and tagged keyword or data associated with the files or folders. In this regard, a user 101 may view all of the files organized as chosen by the user for quick file referencing, without changing, or damaging, a previously organized file tree structure.

Further, in an embodiment, system 200 may be configured to tag files as being non-movable, such that the files may not be moved between different cloud storage accounts 120. It is envisioned that a user 101 may specify which files to mark as non-movable and/or system 200 may automatically mark a file or files as non-movable. For example and without limitation, system 200 may determine to mark a file as non-movable because the file is a part of a larger partitioned file that has been stored on multiple different cloud storage accounts 120.

Further, in an embodiment, system 200 may be configured to detect duplicate files within one cloud storage account 120 and/or between two or more cloud storage accounts 120. In particular, system 200 may detect a duplicate file based on the name of the files, size, content, or data associated with the files, such as the metadata.

Additionally, or alternatively, system 200 may include a trash cache folder. The trash cache folder may be stored in memory 203 or in a designated part of one or more of the cloud storage accounts 120 associated with the user account. The size of the trash cache may be determined by the user 101 or by the system 200. In one embodiment, the trash cache folder has a capacity of 50 MB. System 200 may be configured to notify the user 101 when the trash cache is full or is approaching capacity. In this embodiment, deleted files are transferred to the trash cache folder. Additionally, once files are removed from the trash cache folder, the files may be permanently removed or alternatively moved to another folder within the same cloud storage account 120, a folder on a different cloud storage account 120, or memory 203. The user 101 may specify the file types that must be kept in the trash cache folder when the trash cache folder is approaching capacity. In such an embodiment, system 200 will only remove the file types that were not specified, or otherwise selected, by the user 101 when making space in the trash cache.

Additionally or alternatively, system 200 may be configured to detect the level of available space in each of the cloud storage accounts 120. In this regard, system 200 or the user 101 may select a threshold or limit to the minimum amount of storage space present on the cloud storage account 120. If the system 200 detects that the level of available storage space has exceeded the threshold predefined by the system 200 or user 101 (the amount of available storage space is less than the minimum set by the system 200 or user 101), then system 200 may be configured to carry out one or several of the following steps. In one embodiment, system 200 may be configured to notify the user 101 that the threshold has been exceeded. In another embodiment, system may be configured to automatically create a new account on a new cloud storage account provider 120, or alternatively create a new account on an existing cloud storage account 120 already registered with the user account to increase the overall storage capacity of user account. System 200 may be configured to use the user data stored in memory 203 to create the new accounts with the cloud storage account providers. In another embodiment, system 200 is configured to purchase additional storage space from the existing cloud storage accounts 120 registered with the user account. In this regard, system 200 may also retain a fee, such as a commission, for carrying out the sale of additional storage space.

In an additional embodiment, system 200 is configured to create a conference between multiple users 101. In particular, a user 101 may initiate a conference with one or more other users 101. Each of the users 101 associated with the conference may transfer files to and from their respective cloud storage accounts 120 which are associated with their respective user accounts. It is envisioned that some users 101 associated with the conference may be granted higher level access than other users 101 in the conference. For example one or more users 101 may be assigned “conference moderator” status, such that those users 101 may be the only users in the conference that are capable of performing tasks, such as moving, deleting, transferring, and/or tagging files.

Turning now to FIGS. 3-5, methods 300, 400, 500 are shown and described in particular detail below. Although the methods are shown in the figures and described herein as including particular steps, it is appreciated that some of the steps of the methods may be optional or otherwise not required to perform the methods. Additionally, or alternatively, it is also appreciated that although described in a particular order, the methods described herein may be carried out in any order not explicitly described herein.

With particular reference to FIG. 3, a method for integrating a plurality of cloud storage accounts 120 is shown and described as method 300. Method 300 begins with step 301 by receiving login data of a user 101 which has been previously registered with system 200. In particular, in order for users 101 to access system 200 they will have preregistered their information with the system 200 to create a user account. This user login data is stored in memory 203.

In a particular embodiment, system 200 sends a verification notification, such as and without limitation, an email, to the user 101 and the user 11 clicks on the verification link in order to activate his/her account. In an embodiment, once a user 101 is activated, the user 101 will be required to change the password attached to the user 101 account. In one embodiment, in order to access system 200, the user 101 may login with the username, such as and without limitation and email address, and password.

Continuing with reference to FIG. 3, subsequent to receiving the user login data, the user 101 may access the corresponding user account and method 300 proceeds to step 303. In step 303, system 200 receives a notification of selection of a cloud storage account 120 to associate, or otherwise add, to the user account which is logged in. For example and without limitation, a user 101 can notify system 200 that the user desires to associate cloud storage account 121 to the user's account.

In step 305, system 200 receives login and authentication data for the cloud storage account 120 that was selected in step 303. In an embodiment, a user 101 may input the login identification and password associate with the corresponding cloud storage account 120. In step 307, system 300 proceeds to submit the login and authentication data received in step 305 to the corresponding cloud storage account 120 which was selected in step 303. In an embodiment, step 305 further includes receiving consent from the user 101 for system 200 to access, or otherwise store key or token data, the cloud storage account 120 selected in step 303, as will be described in further detail below with reference to FIG. 6.

In step 309, system 200 determines whether the login and authentication data submitted in step 307 is correct. In particular, in step 309 system 200 attempts to login or otherwise pair with the cloud storage account 120 specified in step 303. If the login information is not correct, and the attempt is unsuccessful (NO in step 309), then method 300 proceeds to step 310. In step 310, system 200, in particular sending unit 207, notifies the user 101 that a login attempt failed. Alternatively, if the attempt is successful (YES in step 309), then method 300 proceeds to step 311. In step 311, system 200 receives an authentication token and stores the token in memory 203 to be associated with the user account.

Subsequent to step 311, method 300 reverts back to step 303 and repeats steps 303-309 until a notification is not received to add further cloud storage accounts 120. Additionally, subsequent to step 311, method 300 proceeds to step 313 where system 200 receives files and/or data associated with the files stored in the cloud storage accounts 120 which were associated with the user account.

In embodiments, method 300 may further include the optional steps 315 and 317. In step 315, system 200 determines the file type received from step 315. In step 317, system 300 categorizes the file received from step 313 based on the file type determined in step 315. In particular, system 200 may store data associated with the files that are stored in the multiple cloud storage accounts 120 linked with the user account, such that a user 101 may select the data associated with the file from the user account in system 200 and system 200 will direct the user 101 to the appropriate destination of the file. Additionally, or alternatively, system may display the file in a display area, as will be described in further detail with reference to FIG. 7 below.

Turning now to FIG. 4, a method for uploading, moving, or transferring a file to a user account, or within and/or between cloud storage accounts 120 of a user account, is shown and described as method 400. In particular, data and files may be locally stored in memory 203 or any other database associated with system 200, as described above, which may then be uploaded to cloud storage accounts 120 associated with a user account.

In some embodiments, method 400 begins with step 401 where system 200 receives user login data. Step 401 is similar to step 301 of method 300. Alternatively, in other embodiments, method 400 may not include step 401. In particular, in some embodiments files are transferred between cloud storage accounts 120 automatically by system 200. Specifically, system 200 may move files between different cloud storage accounts 120 when a user 101 is offline, or otherwise not logged in. This may be useful so as to not be intrusive of a user's experience and workflow while using system 200. By moving files between and/or within cloud storage accounts 120, the files may be kept organized automatically by system 200, system 200 may move files to different folders in the same cloud storage account 120, system 200 may transfer files between different cloud storage accounts 120.

In an embodiment, system 200 runs the background data reallocation described above in order to maximize the capacity of each of the cloud storage accounts 120, such that larger sized files may be uploaded and/or transferred to that cloud storage account 120 if necessary or desired. For example and without limitation, and with reference back to FIG. 1, if cloud storage account 121 has a capacity of 5 GB and cloud storage account 123 has a capacity of 5 GB, and each of cloud storage accounts 121 and 123 have 2.5 GB of free space available, system 200 may automatically, or be prompted to, perform background data reallocation. In this case, the background data allocation algorithm performed by system 200 may transfer all of the files from cloud storage account 121 to cloud storage account 123. Upon completion of the file transfer, cloud storage account 123 is now full with 0 GB of storage space available, and cloud storage account 121 is empty with all of the 5 GB of storage space available. System 200 is now free to upload a file up to 5 GB in size to cloud storage account 121.

In step 403, system 400 receives a command to upload a file and/or folder. In an embodiment, step 403 may include a command to upload a file and/or folder which is locally stored in memory 203. In another embodiment, step 403 may include a command to upload, or otherwise move or transfer, a file and/or folder stored in a particular cloud storage account of the multiple cloud storage accounts 120 associated with the user account. In another embodiment, step 403 may include receiving a command to upload, or otherwise transfer or move, a file and/or folder from one cloud storage account to a different cloud storage account of the multiple cloud storage accounts 120. In one embodiment, the command may include a drag-and-drop operation. In another embodiment, the command may be automatically initiated by the system 200 without user 101 intervention.

Subsequent to receiving the command in step 403, method 400 proceeds to step 405. In step 405, system 200 searches the cloud storage accounts 120 associated with the user account and determines the amount of available storage space in each of the cloud storage accounts 120. In step 407, system 200 determines whether sufficient space is available in any of the cloud storage accounts 120 associated with the user account. In particular, in step 407, system 200 determines the size of the file included in the command received from step 403, and compares the size of the file to the available storage space of each of the cloud storage accounts 120. If sufficient space is available (YES in step 407), then method proceeds to either of steps 412 or 413, which will be described further below. Alternatively, if none of the cloud storage accounts 120 have sufficient space to store the file, then method 400 proceeds to step 409.

In particular, in step 409 system 200 proceeds to split the file and/or folder into different parts to create smaller sized parts. In a particular embodiment, the parts are marked, or otherwise tagged, by system 200 as being non-movable, such that when they are stored in their respective destinations, the files may not be moved (for example in step 403). In particular, with the file split, or otherwise broken-down into smaller parts or partitioned, the smaller parts may each be stored in different cloud storage accounts 120 which include sufficient space to store the parts.

Alternatively, in step 412, system 200 sends a notification including all of the cloud storage accounts 120 that have sufficient space to store the file and/or folder from step 403. In an embodiment, the optional step 412b is included where system 200 receives a selection of which cloud storage account to upload the file to (or move the file to) from the list provided in step 412. It is envisioned that in an embodiment, steps 412 and 412b are accomplished by system 200 displaying to the user 101 via output 211 the options available, and the user 101 may select via input 209, which cloud storage account 120 to specify as the destination for the file.

Subsequent to any of steps 407, 409, 411, 412, and/or 412b, method 400 proceeds to step 413. In step 413, system 200 stores, or otherwise transfers or moves, the file on a cloud storage account 120. The cloud storage account 120 where the file is stored may include the one selected by the user 101 in step 412b, an account automatically determined by the system 200, or multiple cloud storage accounts 120 where the parts from step 409 are respectively stored.

In some embodiments, method 400 may proceed to either or both of steps 415 and 417 which are similar to steps 315 and 317 of method 300 and therefore will not be described.

Turning now to FIG. 5, a method for tagging files and searching integrated cloud storage accounts 120 is illustrated and described as method 500.

Method 500 begins at step 501, where system 200 receives a notification to attach data to a particular file. Upon receiving the notification in step 501, system 200 proceeds to step 503 where system 200 displays a data entry field. The data entry field may be visible on the output 211 via a user interface. In an embodiment, step 501 may include a user 101 notifying system 200 that the user 101 desires to tag a particular file or folder, as will be described in further detail below with reference to FIG. 7. In another embodiment, step 501 is carried out by system 200 upon uploading a locally stored file or folder, such that the system 200 prompts the user 101 to tag data to the file being uploaded, transferred, stored, etc. In yet another embodiment, step 501 is carried out by system 200 upon moving a file, files, a part, or parts of a file between different cloud storage accounts 120.

In step 505, system 200 receives data to attach to the particular file. In an embodiment, step 505 includes a user 101 including keywords, terms, or other identifiers in the data entry field. In step 507, system 200 associates the data received from step 505 and stores the data with the association to the particular file in memory 203.

Steps 501-507 described above relate to tagging data to files that are stored on cloud storage accounts 120 of a user account. Steps 509-517, described below, relate to searching the multiple cloud storage accounts 120 using the data tagged to the files.

In particular, in step 509, system 200 receives a prompt or notification to search for a file amongst the plurality of cloud storage accounts 120. In an embodiment, step 509 is accomplished by a user 101 selecting a module on a graphic user interface prompting the system to perform a search, as will be described in further detail below with reference to FIG. 7. In response to receiving the prompt, at step 511, system 200 displays a search field. In an embodiment, the search field is displayed on output 211 via a graphic user interface. In step 513, system 200 receives search data. In an embodiment, step 513 is accomplished when a user 101 inputs search data via input 209 and transmits the search data to system 200.

In step 511, system 200 proceeds to search all of the cloud storage accounts 120 associated with the user account. In particular, system 200 uses the search data received from step 513 to search the files and the data tagged to, attached to, or otherwise associated with the files from step 507. In an embodiment, the system 200 searches the data, such as the tags, stored in memory 203 for the data to determine where the file associated with the data is located, i.e. which one of the multiple cloud storage accounts 120 that is associated with the user account.

Subsequent to completing step 515, system 200 proceeds to step 517 where the search results are displayed.

Turning now to FIG. 6, a block diagram is shown illustrating an authorization exchange between the system 200 and a cloud storage account 121 according to an embodiment of the present disclosure. In particular, cloud storage authentication and authorization may rely on a two stage process in certain circumstances, depending on the cloud storage account 120 system 200 wishes to link with, such as and without limitation, client application authentication and user authentication/authorization. Some cloud storage account providers authenticate via OAuth protocol. Additionally, several cloud storage account service providers utilize a token based authentication for storage area access, i.e., access to a cloud storage account 120. In an embodiment, client authentication relies on API key provided by the cloud storage account 120 provider after registration of the client Application/service, i.e. system 200. In an embodiment, a client API key and user's access token are both required by API in order to authenticate any user 101 and access the storage area of the cloud storage account 120. Authentication requires the login credential of the user 101 for the respective cloud storage account 120 provider. Once the system 200 provides the credential to the particular cloud storage account 120, in this embodiment, it is required for the system 200 to have obtained consent from the user 101 to allow access for the system 200 to communicate with the cloud storage account 120. If the user 101 allows, i.e., provides the system 200 with the appropriate consent, then the authentication process returns the access token, otherwise the process will invalidate the initial request.

Continuing with reference to FIG. 6, and with particular reference to communication between system 200 and cloud storage account 121, which may be for example and without limitation, Google Drive®. Google® uses OAuth 2.0 mechanism of authentication. As such, the user 101 needs to be registered and must have an account set up with both system 200 and cloud storage account 120 (Google Drive®) in order to obtain the OAuth token. A single access token in this case grants access to multiple API. System 200 request for Google Drive® integration requires the login to Google®. After logging in, the user 101 can see a set of permissions requested by application. If the user 101 is willing to grant permission to system 200, the relevant Google® API will be available for system 200 to use corresponding to the OAuth token.

With particular reference to communication between system 200 and cloud storage account 123, which may be for example and without limitation, DropBox®. The user 101 needs to have an account with Dropbox® cloud storage in order to connect Dropbox® cloud storage with system 200. Dropbox® authentication is compliant with the OAuth v1 specification. The first step of authentication is to obtain an OAuth request token to be used for the rest of the authentication process. Once the user 101 has successfully granted permission to system 200, the authorized request token needs to be upgraded to an access token by another API. Any API request through system 200 needs to be signed with the stored access token for relevant user account associated with the user 101.

With particular reference to communication between system 200 and cloud storage account 125, which may be for example and without limitation Box.net®. In order to add Box.net® on to system 200, users 101 need to have an account with Box.net®. Box.net® provides API's to integrate with third patty client applications, such as system 200. The authentication and authorization process is driven by an authentication token. The authentication token for a user 101 is stored in memory 203 of system 200 for further access to the cloud storage account 125.

Turning now to FIGS. 7-11, drawings of exemplary user interfaces are shown that may produced by system 200 for display on output 211 and/or devices 110. The user interface screen illustrated and described herein may be a web page corresponding to a website maintained by one or more computing devices, such as servers. The user interface screens may be accessible by users 101 via a web browser, such as and without limitation Internet Explorer®, Firefox®, Chrome®, etc., via devices 110.

With particular reference to FIG. 7, a drawing of an exemplary user interface screen 700 is shown illustrating a variety of functions 701 which may be initiated by a user 101 which causes system 200 to perform the methods and processes described herein. The functions 701 may be arranged and displayed in any order not explicitly illustrated in user interface screen 700.

User interface screen 700 includes cells 703 that a user 101 may activate, or otherwise select to cause system 200 to perform a specific function. Cells 703 include access to the cloud storage accounts 120 associated with the user account. In particular, cells 703 include a cell 703a to access cloud storage account 121, cell 703b to access cloud storage account 123, and cell 703c to access cloud storage account 125. In an embodiment, when a user 101 selects one of the cells 703a, 703b, 703c, the files stored in the corresponding cloud storage account 121, 123, 125 is displayed in display area 705. Additionally, or alternatively, the files may be visible below the cell 703 selected.

Continuing with reference to FIG. 7, functions 701 include new file 701a, rename 701b, delete 701c, download 701d, cut 701e, upload 701f, copy 701g, add to my favorites 701h, move 701i, paste, 701j, split 701k, add tags 7011, share 701m, and add folder 701n. In an embodiment, a new file can be created in the selected space (selected cloud storage account 120) by clicking on the new file function 701a.

In an embodiment, selecting the new file function 701a causes system 200 to notify the user 101 to choose the type of application, i.e. file, the user 101 would like to create in the selected space and if space is available, a new file would be created in the selected space.

Further, in an embodiment, a file in the selected space can be renamed by selecting the respective file and clicking on the rename function 701b. In this embodiment, selecting the rename function 701b causes the system 200 to prompt the user 101 to enter new name for the file and the specified file would be renamed after user 101 confirms the new name for the specified file in the selected space for specific cloud storage area.

Further, in an embodiment, a file in the selected space can be deleted by selecting the respective file and clicking on the delete function 701c. In this embodiment, selecting the delete function 701c causes the system 200 to delete the file from the selected space in the respective cloud storage account 120 after confirming deletion of file. This may cause the system 200 to move the file to the trash cache described above.

Further, in an embodiment, a file in the selected space could be downloaded to the user's or system 200 local memory 203 by selecting the respective file and clicking the download function 701d. In this embodiment, selecting the download function 701d causes the system 200 to initiate downloading of the respective file to the memory 203.

Further, in an embodiment, a file can be uploaded to system 200 by selecting the space for particular cloud storage service provider and then selecting the upload function 701e. In this embodiment, selecting the upload function 701f causes the system 200 to carry out method 400 described above with reference to FIG. 4. In an embodiment, selecting the upload function 701f causes system 200 to present a list of all of the files stored in memory 203 for a user 101 to select.

Further, in an embodiment, a file can be cut and stored in a clipboard by selecting the specified file in the selected space and selecting the cut function 701e. The clipboard may include a cache memory, memory 203, cloud storage accounts 120, and any combinations thereof. Selecting the cut function 701e causes the system 200 to move the selected file from the selected space to the clipboard. If the file is not pasted anywhere, then the file may be restored back to the old destination after a predetermined period of time lapses.

Further, in an embodiment, a file can be copied to the clipboard by selecting the specified file in the selected space for cloud storage and then selecting the copy function 701g. Selecting the copy function 701g causes the system 200 to copy the specified file to the clipboard. If the file is not copied anywhere, then the copied file will be dropped from clipboard as described above.

Further, in an embodiment, a file can be added to My Favorites, or another specified folder, by selecting the respective file(s) in the selected space for cloud storage and selecting the my favorites function 701h. Selecting the my favorites function 701h causes the system 200 to add the specified file(s) to ‘My Favorites’ section in system 200.

Further, in an embodiment, a file can be moved to a particular location by selecting the specified file in the selected space for cloud storage and selecting the move function 701i. Selecting the move function 701i causes the system 200 to prompt the user 101 to designate a destination for the file. After confirming the destination, the system 200 proceeds to move the selected file from the origin to the destination.

Further, in an embodiment, a file can be pasted in the selected space by first selecting the specified space in which file(s) are to be pasted and selecting the paste function 701j. In an embodiment, all the file(s) in the clipboard will be pasted in the selected space after confirming the space availability. Additionally, or alternatively, the paste function 701j may be disabled if there is no data in the clipboard, and will not be enabled until data is included in the clipboard.

Further, in an embodiment, a file or folder can be split into fragments, or otherwise partitioned into parts, by selecting the specified file in the selected space and selecting the split function 701k. Selecting the split function 701k may cause the system 200 to perform the steps described in method 400 (FIG. 4).

Further, in an embodiment, a tag, or other data, may be added to a file, or the metadata of a file, by selecting the specific file in the selected space and selecting the add tags function 701l. Selecting the add tags function 701l causes the system 200 to prompt the user 101 to add keywords or other data to associate with the file selected as described in method 500 in FIG. 5.

Further, in an embodiment, a file can be shared with various other users 101, and non-users, by selecting the specified file to be shared in the selected space and selecting the share function 701m. Selecting the share function 701m causes the system 200 to prompt the user 101 to enter the email addresses, or other destination information, of various other users 101 and/or non-users with whom file is to be shared. In an embodiment, an e-mail, or other suitable communication, would be sent to specified e-mail addresses, or destination, with the URL of the respective file.

Further, in an embodiment, a folder can be added to the selected space by selecting the space where folder is to be created and selecting the add folder function 701n. After that, system 200 creates a folder in one or more of the cloud storage accounts 120.

Also included in user interface 700 is a search function 707. By selecting the search function 707, a user 101 causes the system 200 to begin carrying out steps 509-517 of method 500 described above with reference to FIG. 5. In particular, cloud storage account 120 provides an API to search the files based on the metadata. As described above, a user 101 can introduce additional tags for each of the files to be associated with the files and the system 200 can cause the API to perform the search on additional as well as standard tags. System 200 provides an integrated space where all files are listed irrespective of the cloud storage account 120 that the file or files are located. In this regard, users 101 can search the files that are stored on multiple cloud storage accounts 120 in one central user account. In an embodiment, the aggregated search result will be listed as a search result in area 705. Additionally, using the search function 707, a user 101 can perform a search within a single specified cloud storage account 120 as well.

Turning now to FIG. 8, a user interface 800 is shown which includes a split-screen view of two different cloud storage accounts 120 associated with the user account. Although only two cloud storage accounts 120 are shown in user interface 800, system 200 may also be configured to display three or more of the cloud storage accounts 120 on a single screen or user interface.

Turning now to FIG. 9, a user interface screen is shown where a user 101 may cause system 200 to move files between multiple cloud storage accounts 120 and between cloud storage accounts 120 and system 200 using any of the functions, processes, and/or methods described herein. In particular, in FIG. 9 system 200 is prompted to move a file by a drag-and-drop operation. In an embodiment, and as illustrated in FIG. 9, the storage spaced used in the memory 203 of system 200 may be displayed in the user interface. In an embodiment, as described above, memory 203 of system 200 may include storage space provided by one or several cloud storage accounts, including any of cloud storage accounts 120 that are associated with the user account.

Turning now to FIG. 10, a user interface is shown where a user 101 may cause system 200 to move files associated with system 200 to conferences for viewing by other users 101 or non-users associated with the respective conference. As described above, the files associated with system 200 may be stored locally on the memory 203 of system 200 and/or may be stored on one or several cloud storage accounts 120.

Turning now to FIG. 11 yet another user interface screen is shown where the user interface displays each of the cloud storage accounts 120 that are associated with a particular user account within system 200 and the files stored on the respective cloud storage accounts 120. In particular, the storage space being utilized on each of the cloud storage accounts 120 is shown for the respective cloud storage account 120. In an embodiment, should the user 101 or the system 200 desire or require to free up space in a particular cloud storage account 120, system 200 may be prompted to move a file or folder from one cloud storage account 120 to another using any of the methods, functions, and/or processes described herein or otherwise appreciated in the art.

Although, the above-described embodiments have been described as being applicable to cloud storage account integration and management, it is envisioned that any of the above-described embodiments may be implemented in any integration system and may be used integrate and manage any storage means not described above.

Further, although the above-described embodiments have been described as including particular functions, components, and elements, it is envisioned that the embodiments disclosed herein may include some or all of the functions, components, and elements described. Additionally, any of the embodiments described herein may be partially or entirely combined with any other embodiments described herein, in whole or in part.

Many modifications and other embodiments set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed and that modifications and other embodiments are intended to be included within the scope of the appended claims. Although specific terms are employed herein, they are used in a generic and descriptive sense only and not for purposes of limitation.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

What is claimed is:

1. A method for integrating a plurality of cloud storage accounts, comprising:
receiving login data of a user account;
receiving a notification of at least one of the cloud storage accounts to associate with the user account;
receiving authentication data of the at least one cloud storage accounts;
transmitting the authentication data to the respective cloud storage account;
receiving at least one authentication token from each of the respective cloud storage accounts when the authentication data is verified;
storing the at least one authentication token in a database and associating the at least one authentication token with the user account; and
receiving at least data of at least one file stored on at least one cloud storage account associated.

2. The method according to claim 1, wherein the data of at least one file received includes data corresponding to a type of file, and the method further comprises categorizing the at least one file based on the type of file.

3. The method according to claim 1, further comprising:
receiving a command to upload at least one local file;
searching the at least one cloud storage account and determining if sufficient space is available to store the local file in at least one cloud storage account.

4. The method according to claim 3, wherein when sufficient space is available in at least one cloud storage account, storing the local file in at least one cloud storage account with sufficient space available.

5. The method according to claim 3, wherein when sufficient space is not available in at least one cloud storage account, splitting the local file into parts and storing each of the parts in a different cloud storage account.

6. The method according to claim 5, further comprising marking the parts as non-movable.

7. The method according to claim 3, further comprising:
receiving data corresponding to at least one of the local file and at least one file stored on any cloud storage account;
associating the data with the respective file; and
searching the files based on the data associated with the files.

8. The method according to claim 1, further comprising:
determining whether at least one of the cloud storage accounts includes an available capacity below a predefined threshold level; and
notifying the user account that at least one of the cloud storage accounts includes an available capacity below the predefined threshold level.

9. A system for integrating a plurality of cloud storage accounts, comprising:
a processor; and
a memory storing instructions executable by the processor, wherein the instructions when executed by the processor cause the system to:
receive login data of a user account;
receive a notification of at least one of the cloud storage accounts to associate with the user account;
receive authentication data of the at least one cloud storage accounts;
transmit the authentication data to the respective cloud storage account;
receive at least one authentication token from each of the respective cloud storage accounts when the authentication data is verified;
store the at least one authentication token in a database and associate the at least one authentication token with the user account; and
receive at least data of at least one file stored on at least one cloud storage account associated.

10. The system according to claim 9, wherein the data of at least one file received includes data corresponding to a type of file, and wherein the instructions when executed by the processor further cause the system to categorize the at least one file based on the type of file.

11. The system according to claim 9, wherein the instructions when executed by the processor further cause the system to:
receive a command to upload a local file;
search the at least one cloud storage account and determine if sufficient space is available to store the local file in at least one cloud storage account.

12. The system according to claim 11, wherein the instructions when executed by the processor further cause the system to store the local file in at least one cloud storage account when sufficient space is available in at least one cloud storage account.

13. The system according to claim 11, wherein the instructions when executed by the processor further cause the system to split the local file into parts and store each of the parts in a different cloud storage account when sufficient space is not available in at least one cloud storage account.

14. The system according to claim 13, wherein the instructions when executed by the processor further cause the system to mark the parts as non-movable.

15. The system according to claim 11, wherein the instructions when executed by the processor further cause the system to:
receive data corresponding to at least one of the local file and at least one file stored on any cloud storage account;
associate the data with the respective file; and
search the files based on the data associated with the files.

16. The system according to claim 9, wherein the instructions when executed by the processor further cause the system to:
determine whether at least one of the cloud storage accounts includes an available capacity below a predefined threshold level; and
notify the user account that at least one of the cloud storage accounts includes an available capacity below the predefined threshold level.

17. A non-transitory computer-readable storage medium storing instructions which, when executed by a computer, cause the computer to perform a method for integrating a plurality of cloud storage accounts, comprising:
receiving login data of a user account;
receiving a notification of at least one of the cloud storage accounts to associate with the user account;
receiving authentication data of the at least one cloud storage accounts;
transmitting the authentication data to the respective cloud storage account;
receiving at least one authentication token from each of the respective cloud storage accounts when the authentication data is verified;
storing the at least one authentication token in a database and associating the at least one authentication token with the user account; and
receiving at least data of at least one file stored on at least one cloud storage account associated.

18. The non-transitory computer-readable storage medium according to claim 17, wherein the data of at least one file received includes data corresponding to a type of file, and wherein the instructions when executed by the computer further cause the computer to categorize the at least one file based on the type of file.

19. The non-transitory computer-readable storage medium according to claim 17, wherein the instructions when executed by the computer further cause the computer to:
receive a command to upload a local file;
search the at least one cloud storage account and determine if sufficient space is available to store the local file in at least one cloud storage account.

20. The non-transitory computer-readable storage medium according to claim 19, wherein the instructions when executed by the computer further cause the computer to store the local file in at least one cloud storage account with sufficient space available when sufficient space is available in at least one cloud storage account.

21. The non-transitory computer-readable storage medium according to claim 19, wherein the instructions when executed by the computer further cause the computer to split the local file into parts and store each of the parts in a different cloud storage account when sufficient space is not available in at least one cloud storage account.

22. The non-transitory computer-readable storage medium according to claim 19, wherein the instructions when executed by the computer further cause the computer to:
receive data corresponding to at least one of the local file and at least one file stored on any cloud storage account;
associate the data with the respective file; and
search the files based on the data associated with the files.
